(19) United States
(12) Patent Application Publication
(10) Pub. No.: US 2010/0026961 A1
(43) Pub. Date: Feb. 4, 2010

(54) LIGHT MODULATION DEVICE MODULE, IMAGE FORMING APPARATUS USING THE MODULE, AND DRIVING METHOD FOR THE APPARATUS

(75) Inventor: Kazunao ONIKI, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/489,969

(22) Filed: Jun. 23, 2009

(30) Foreign Application Priority Data
Jul. 29, 2008 (JP) 2008-195483

(51) Int. Cl. G03B 21/00; G02F 1/00

(52) U.S. Cl. 353/31; 359/237

(57) ABSTRACT

A light modulation device module includes a support member, a light modulation device provided on the support member, the light modulation device modulating a plurality of linear light beams in different wavelength bands, a driving unit configured to drive the light modulation device, and a light transmitting member provided on the light modulation device.

### BACKGROUND OF THE INVENTION

1. Field of the Invention

The present invention relates to an optical modulation device module including a light modulation device, for example, of a one-dimensional diffraction grating, an image forming apparatus using the module, and a driving method for the apparatus.

2. Description of the Related Art

There has been proposed an image forming apparatus, such as a projector or a printer, in which a two-dimensional image is formed by projecting a light beam from a one-dimensional light modulation device onto an image forming device while scanning the light beam by an optical scanning device (for example, see Japanese Patent Nos. 3401250 and 3164824). Examples of one-dimensional light modulation devices are a GLV (Grating Light Valve) of a so-called one-dimensional diffraction grating type in which light modulation elements formed by diffraction gratings are one-dimensionally arranged in an array, a laser array, and a liquid crystal modulation device. A normal light modulation device, such as a GLV, further includes a plurality of light transmitting members, such as glass plates, which are provided corresponding to red, green, and blue colors, and which transmit light incident on the light modulation device and modulated light emitted from the light modulation device. The light modulation elements in the GLV light modulation device are manufactured by using a micromachining manufacturing technique. Each of the diffraction grating type light modulation elements is formed by a reflective element, and has a light switching function. The light modulation element can electrically control the on and off states of light, and thereby emits modulated light corresponding to an image signal. Therefore, by scanning light emitted from the light modulation element by a scanning mirror, a two-dimensional image is formed. For example, to display a two-dimensional image defined by M×N (e.g., 1920×1080) pixels, a light modulation device is constituted by an N-number of (=1080) light modulation elements. Further, to display a color image, three light modulation devices are used.

As an example, FIG. 15 schematically shows the layout of a lower electrode 122, fixed electrodes 131, movable electrodes 132, etc. that constitute a light modulation element 121 of a one-dimensional diffraction grating type. FIG. 16A is a schematic partial cross-sectional view of a fixed electrode 131 and so on, taken along line XVIA-XVIA in FIG. 15, FIGS. 16B and 17A are schematic partial cross-sectional views of a movable electrode 132 and so on, respectively, taken along line XVIB-IVIB and XVIIA-XVIIA in FIG. 15, and FIG. 17B is a schematic partial cross-sectional view of fixed electrodes 131, movable electrodes 132 and so on, taken along line XVIIB-XVIIB in FIG. 15. Here, a state of the movable electrodes 132 before displacement is shown in FIG. 16B and on the left side of FIG. 17B, and a state of the movable electrodes 132 after displacement is shown in FIG. 17A and on the right side of FIG. 17B. In FIG. 15, the lower electrode 122, the fixed electrodes 131, the movable electrodes 132, and support portions 123 to 126 are marked with diagonal lines and the like for explicit illustration.

In the light modulation element 121, the lower electrode 122, the fixed electrodes 131 shaped like a ribbon, and the movable electrodes 132 shaped like a ribbon are provided on a support member 112 formed of, for example, Si. The lower electrode 122 is formed of, for example, polysilicon doped with impurities. The fixed electrodes 131 are supported and stretched by the support portions 123 and 124 above the lower electrode 122. Further, the movable electrodes 132 are supported and stretched by the support portions 125 and 126 above the lower electrode 122, and are arranged beside the fixed electrodes 131. For example, the fixed electrodes 131 and the movable electrodes 132 are each provided as a laminated structure of a dielectric material layer (lower layer) of SiN and a light reflecting layer (upper layer) of Al mixed with Cu. While the support portions 123 to 126 have cavities therein in the figures, they can have other various structures.

One light modulation element 121 includes one, two, or three fixed electrodes 131 and corresponding movable electrodes 132 (three fixed electrodes 131 and three movable electrodes 132 are provided in the illustrated example). A combination of (three in this case) movable electrodes 132 are connected to a control electrode, and the control electrode is connected to a connecting terminal portion (not shown). In contrast, the fixed electrodes 131 are connected to a bias electrode. The bias electrode is common to a plurality of light modulation elements 121, and is grounded via a bias electrode terminal portion (not shown). The lower electrode 122 is also common to a plurality of light modulation elements 121, and for example, is grounded via a lower-electrode terminal portion (not shown).

In FIGS. 15 to 17, the longitudinal direction of the ribbon-shaped fixed electrodes 131 and movable electrodes 132 is designated as the X-direction, and the width direction of the electrodes 131 and 132 orthogonal to the X-direction is designated as the Y-direction. When the light modulation elements 121 for 1080 pixels are arranged in the Y-direction, as described above, 1080×6 electrodes are arranged.

In the light modulation element 121 having the above-described structure, when voltage is applied to the movable electrodes 132 via the connecting terminal portion and the control electrode and voltage is applied to the lower electrode 122 (for example, the lower electrode 122 is in a grounded state), an electrostatic force (Coulomb force) is generated between the movable electrodes 132 and the lower electrode 122. By this electrostatic force, the movable electrodes 132 are displaced downward toward the lower electrode 122. On the basis of this displacement of the movable electrodes 132, the movable electrodes 132 and the fixed electrodes 131 form a reflective diffraction grating.

Assuming that d represents the distance between the adjacent fixed electrodes 131 shown in FIG. 17B, θi represents the incident angle of light incident on the movable electrodes 132 and the fixed electrodes 131, λ represents the wavelength, and θm represents the diffraction angle, the following relationship is provided:

d×[sin(θi)−sin(θm)]=m×λ

Here, m is an order, and takes values 0, ±1, ±2, . . . .

When the difference Δh1 (see FIG. 17B) in height between the top faces of the movable electrodes 132 and the top faces of the fixed electrode 131 is (λ/4), the intensity of diffracted light becomes the highest.

FIG. 18 schematically shows a configuration of an example of an image forming apparatus using this light modulation device. An image forming apparatus 100 includes a red light source 100R, a green light source 100G, and a blue light source 100B, light modulation devices 105R, 105G, and 105B, a light combining unit 106, a space filter 107, a scanning optical unit 108, and a projection optical unit 109. Each of the light sources 100R, 100G, and 100B is formed by, for example, a semiconductor laser. The light modulation devices 105R, 105G, and 105B respectively modulate light beams emitted from the light sources 100R, 100G, and 100B, and are controlled by a control unit (not shown). The light combining unit 106 is formed by, for example, an L-shaped prism, and combines optical paths of the light beams modulated by the light modulation devices 105R, 105G, and 105B. The space filter 107 is formed by, for example, a Schlieren filter, and selects diffracted light of light L whose optical paths are combined by the light combining unit 106. The scanning optical unit 108 scans the selected diffracted light onto a display surface 110.

In this image forming apparatus 100, red laser light Lr1, green laser light Lg1, and blue laser light Lb1 emitted from the light sources 100R, 100G, and 100B are respectively modulated by the light modulation devices 105R, 105G, and 105B via mirrors (not shown) according to image signals, and are combined into one light beam L1 by the L-shaped prism 106 via mirrors (not shown), and the light beam L1 enters the space filter 107. The laser light beam L1 passing through the space filter 107 enters the scanning optical unit 108, such as a galvanometer mirror or a polygonal mirror, via an imaging lens (not shown). By the rotation or turn of the scanning optical unit 108 in the direction of arrow r1, the laser light beam L is scanned via the projection optical unit 109, as shown by arrows 11, 12, 13, . . . , and is projected onto the display surface 110, such as a screen, in a scanning direction shown by arrow S1, whereby an image is formed on the display surface 110.

The laser light beams traveling from the light sources 100R, 100G, and 100B to the light modulation devices 105R, 105G, and 105B are concentrated to a predetermined spot size in the X-direction shown in FIGS. 15 to 17, and are shaped into linear light beams collimated to a predetermined width in the Y-direction.

In a non-operation state in which no driving voltage is applied to the movable electrodes 132 of the above-described light modulation elements 121 in the light modulation devices 105R, 105G, and 105B, light reflected by the top faces of the movable electrodes 132 and the fixed electrodes 131 is blocked by the space filter 107. In contrast, in an operation state shown in FIG. 17A or on the right side of FIG. 17B in which the movable electrodes 132 are driven, ±1-order (m=±1) diffracted light diffracted by the movable electrodes 132 and the fixed electrodes 131 passes through the space filter 107. With this configuration, the on/off state of the light projected on the display surface 110 is controlled. Further, by controlling the voltage applied to the movable electrodes 132, the height difference Δh1 between the top faces of the movable electrodes 132 and the top faces of the fixed electrodes 131 can be changed to change the diffracted light intensity. This allows accurate gradation control.

This light modulation device of the diffraction grating type can perform display with high resolution, high-speed switching, and wide bandwidth by appropriately selecting the dimensions of the movable electrodes 132. Further, since the light modulation device can be operated with a relatively low voltage, realization of a quite small projection image forming apparatus can be expected. Moreover, in contrast to an ordinary two-dimensional image display device, for example, a projection display device using a liquid crystal panel, this image forming apparatus performs scanning with the scanning optical unit 108, and therefore, can display extremely smooth and natural images. In addition, since the image forming apparatus combines laser light beams from the light sources corresponding to three primary colors, that is, red, green, and blue, it offers excellent display performance, for example, an extremely wide color reproduction range and display of natural color images.

### SUMMARY OF THE INVENTION

As described above, in the image forming apparatus of the related art applied to a projector or the like, three light modulation devices are used to respectively modulate the intensities of light beams of three colors, red, green, and blue. However, if the light modulation devices are displaced, the position where laser light of each color is applied and the emitting direction of reflected light of the laser light are displaced. The displacement appears as pixel displacement on the display surface 110. For example, to display a high-definition image defined by 1080 vertical pixels and 1920 horizontal pixels, even when a displacement of a ¼ pixel is permitted, an accuracy corresponding to 1/4320 of the total vertical pixel size (Y-direction) and of 1/7680 of the total horizontal pixel size (the X-direction) is provided. Further, even when pixels of the three light modulation devices are perfectly aligned in the initial state, pixel displacement also appears because of the temperature change, mechanical bonding position accuracy, etc.

When the support member 112 shown in FIGS. 16 and 17 is fixed onto a wiring board formed of ceramic such as Al₂O₃, the coefficient of thermal expansion of the wiring board is about 3.1×10⁻⁶/K, and a temperature difference of 1° C. causes a displacement corresponding to 3.1 ppm of the element length.

It is desirable to facilitate adjustment of the relative optical position among light modulation elements corresponding to a plurality of colors when an image is formed by modulating the colors, and to minimize pixel displacement for each color due to heat generation.

A light modulation device module according to an embodiment of the present invention includes a support member; a light modulation device provided on the support member, the light modulation device modulating a plurality of linear light beams in different wavelength bands; a driving unit configured to drive the light modulation device; and a light transmitting member provided on the light modulation device.

An image forming apparatus according to another embodiment of the present invention includes a light source configured to emit light beams in different wavelength bands; a light combining unit configured to combine the light beams from the light source; a light modulation device module on which the light beams are incident after optical paths of the light beams adjusted by the light combining unit; a control unit configured to output a driving signal corresponding to an image signal to a light modulation device in the light modulation device module; and a scanning optical unit configured to scan the light beams modulated by the light modulation device onto a display surface. This light modulation device module has the configuration of the above-described light modulation device module. That is, the light modulation device module includes a support member, a light modulation device provided on the support member, the light modulation device modulating a plurality of linear light beams in different wavelength bands; a driving unit configured to drive the light modulation device; and a light transmitting member provided on the light modulation device.

A driving method for an image forming apparatus according to a further embodiment of the present invention includes the steps of: modulating linear light beams in different wavelength bands according to an image signal by a light modulation device of a one-dimensional diffraction grating type, the light modulation device being provided on a support member to form a light modulation device module, and scanning the modulated light beams onto a display surface in a time division manner.

As described above, in the light modulation device module, the image forming apparatus using the module, and the driving method for the apparatus according to the embodiments of the present invention, the light modulation device module including the light modulation device for modulating a plurality of linear light beams in different wavelength bands is used. By thus providing the light modulation device for, for example, color, green, and blue light beams in different wavelength bands in the single light modulation device module, the above-described adjustment of the relative optical position among light modulation devices is facilitated greatly. Further, by providing a plurality of or one light modulation device corresponding to the wavelength bands on the same support member, displacement is prevented from being caused with time by thermal expansion of the support member. Therefore, it is possible to minimize displacement of the light modulation device and pixel displacement with time on the display surface.

According to the embodiments of the present invention, when an image is formed by modulating light beams of a plurality of colors, the relative optical position among the light modulation devices corresponding to the colors can be easily adjusted, and pixel displacement for each color due to heat generation can be minimized.

### BRIEF DESCRIPTION OF THE DRAWINGS

FIG. 1 is a schematic cross-sectional structural view of a light modulation device module according to an embodiment of the present invention.

FIG. 2 is a schematic structural plan view of a light modulation device module of the related art.

FIG. 3 is a schematic structural plan view of the light modulation device module according to the embodiment of the present invention.

FIG. 4 is a schematic structural view an image forming apparatus according to an embodiment of the present invention.

FIG. 5 is a schematic structural plan view of the principal part of the image forming apparatus of the embodiment.

FIGS. 6A and 6B are schematic structural plan views of light modulation device modules according to embodiments of the present invention.

FIG. 7 is a schematic structural plan view of a light modulation device module according to an embodiment of the present invention.

FIG. 8 is a schematic structural view of the principal part of the light modulation device module of the embodiment.

FIGS. 9A and 9B are schematic structural plan views of light modulation device modules according to embodiments of the present invention.

FIG. 10 is a schematic structural plan view of a light modulation device module according to an embodiment of the present invention.

FIGS. 11A to 11C are explanatory views illustrating a driving method for an image forming apparatus according to an embodiment of the present invention.

FIG. 12 is a graph showing the rise response speed of a light modulation device of a diffraction grating type.

FIGS. 13A and 13B are explanatory views illustrating a driving method for an image forming apparatus according to an embodiment of the present invention.

FIG. 14 is a graph showing an example of a change in linear thermal expansion of a light modulation element due to a temperature change.

FIG. 15 is a schematic structural plan view of a light modulation device of a diffraction grating type.

FIGS. 16A and 16B are schematic structural side views of the principal part of the light modulation device of the diffraction grating type.

FIGS. 17A and 17B are a schematic structural side view and a schematic structural sectional view, respectively, of the principal part of the light modulation device of the diffraction grating type.

FIG. 18 is a schematic structural view of an image forming apparatus of the related art.

### DESCRIPTION OF THE PREFERRED EMBODIMENTS

While best modes for carrying out the present invention will be described below, it should be noted that the present invention is not limited to the following modes.

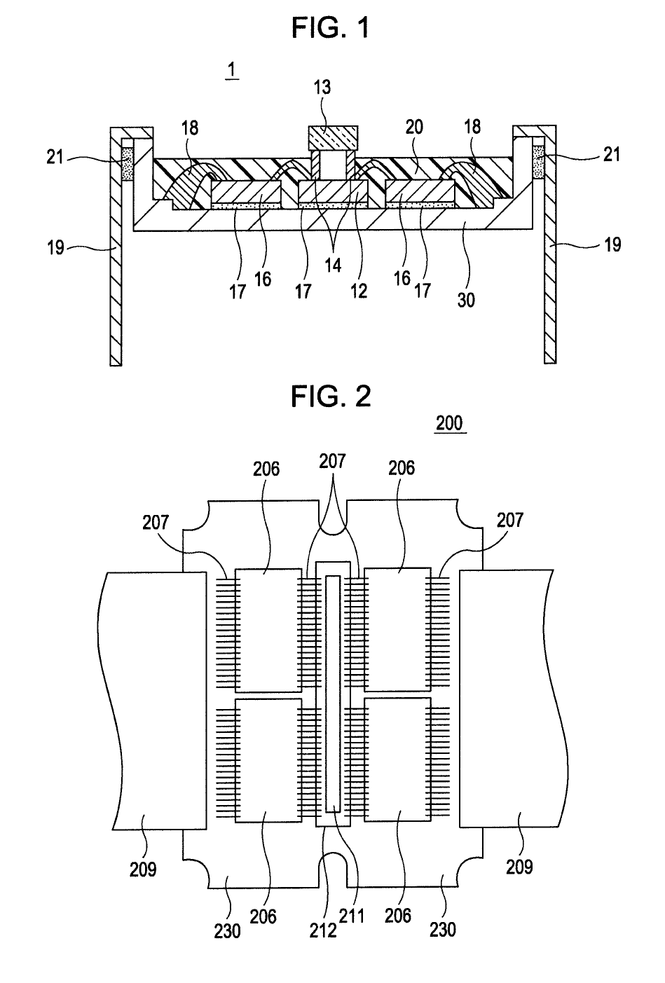

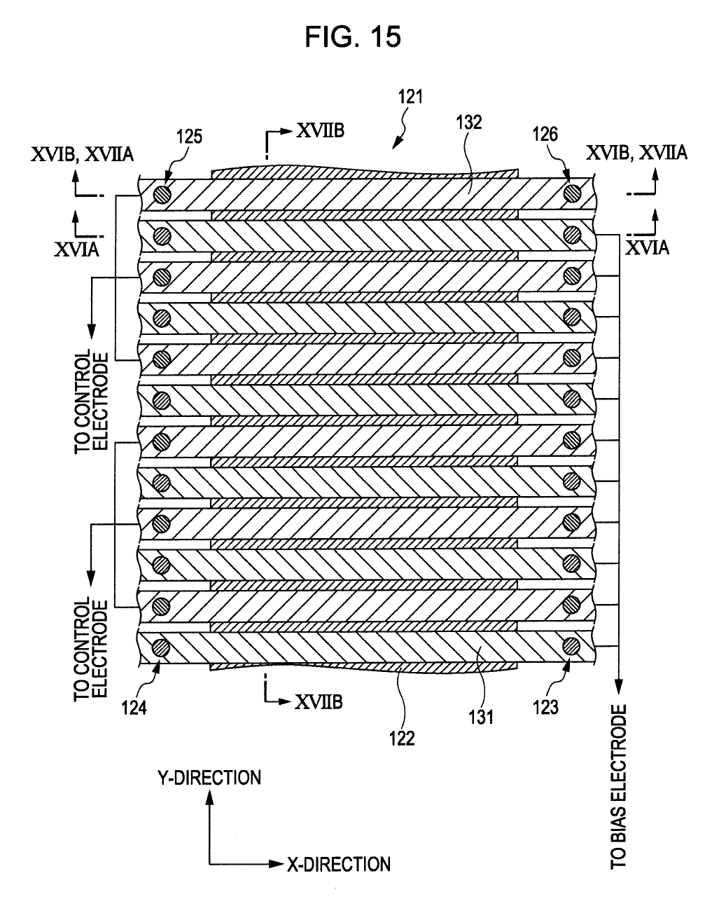

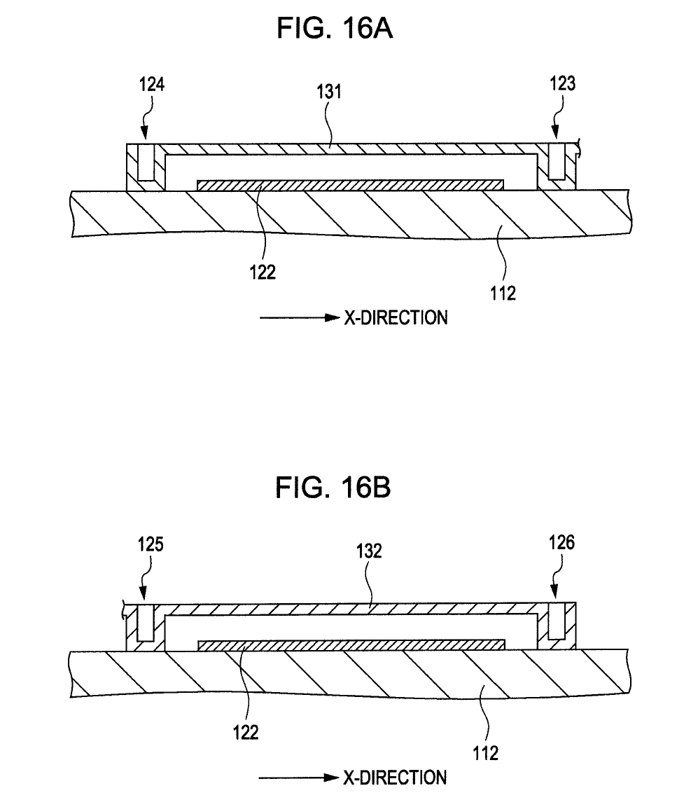

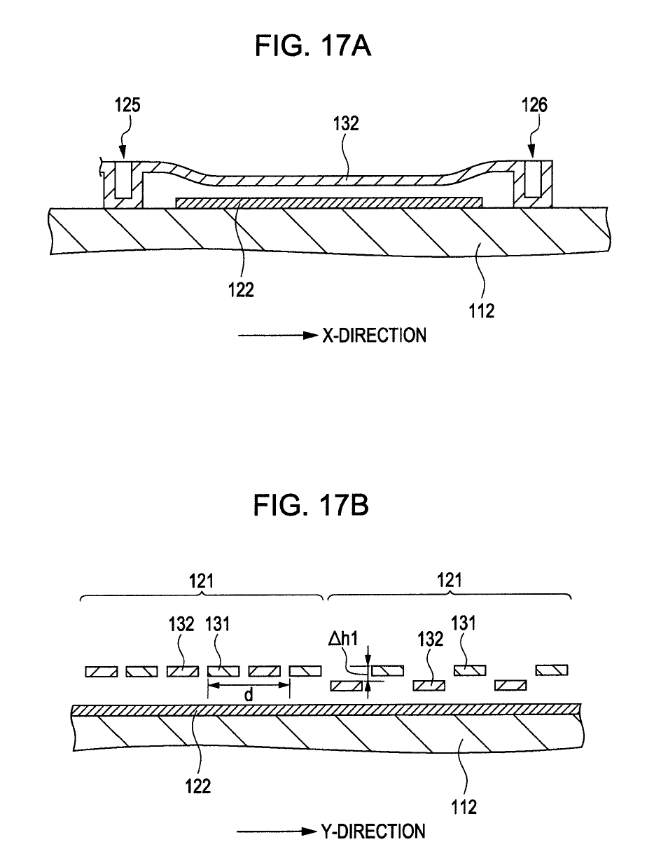

FIG. 1 is a schematic structural cross-sectional view of a light modulation device module 1 according to an embodiment. Referring to FIG. 1, in the light modulation device module 1, light modulation devices 12 for modulating a plurality of linear light beams in different wavelength bands are provided on a support member 30. As the light modulation device 12, for example, the light modulation device of a one-order diffraction grating type shown in FIGS. 15 to 17 can be used. Alternatively, a laser array, liquid crystal panels arranged in a one-dimensional form, or the like can be used. In FIG. 1, electrodes of light modulation elements in the light modulation devices 12 are not shown.

A light transmitting member 13 for protecting the light modulation elements (not shown) is provided above the light modulation devices 12 with support portions 14 disposed therebetween. The light transmitting member 13 is provided in a hermetical manner, and may be filled with gas or the like. For example, when a hydrogen gas, a helium gas, a nitrogen gas, or a mixture of these gases is sealed, it is possible to prevent fixed electrodes and movable electrodes from being deteriorated by the temperature gradient caused by the temperature rise during operation of the light modulation elements, and to thereby improve durability and reliability. Preferably, the support member 30 is formed by a ceramic laminated body and has a wiring circuit and so on therein. As shown in FIG. 1, the support member 30 may have a recess in which the light modulation devices 12 and so on are provided. On the support member 30, driving units 16 each formed by a semiconductor device and having a circuit for driving the light modulation elements of the light modulation devices 12 are also provided.

The light modulation devices 12 and the driving units 16 are fixed to the support member 30 with adhesive 17. The light modulation devices 12 and the driving units 16 are electrically connected by, for example, wiring bonding using wires 18. The driving units 16 are also connected to wiring circuits provided in the support member 30. In this case, the light modulation devices 12 and the driving units 16 are arranged in the recess of the support member 30, and are sealed by potting resin 20 for the purpose of protection of wire bonding. Further, flexible wiring boards 19 are connected to edges of the support member 30. The flexible wiring boards 19 may be fixed to side faces of the support member 30 with adhesive 21 made of resin.

FIG. 2 is a schematic structural plan view of a light modulation device module 200 of the related art. In this case, a light modulation device 212 having a light modulation element 211 and driving units 206 are provided on a support member 230 formed of ceramic. In the related art, as shown in FIG. 2, the light modulation device 212 corresponding to light in a single wavelength band is provided on the single support member 230. In the example shown in FIG. 2, four driving units 206 are provided for the single light modulation device 212. The light modulation device 212 is connected to the driving units 206, and the driving units 206 are connected to wiring circuits (not shown) on the support member 230, for example, by wire bonding using wires 207. Further, flexible wiring boards 209 are connected to the support member 230.

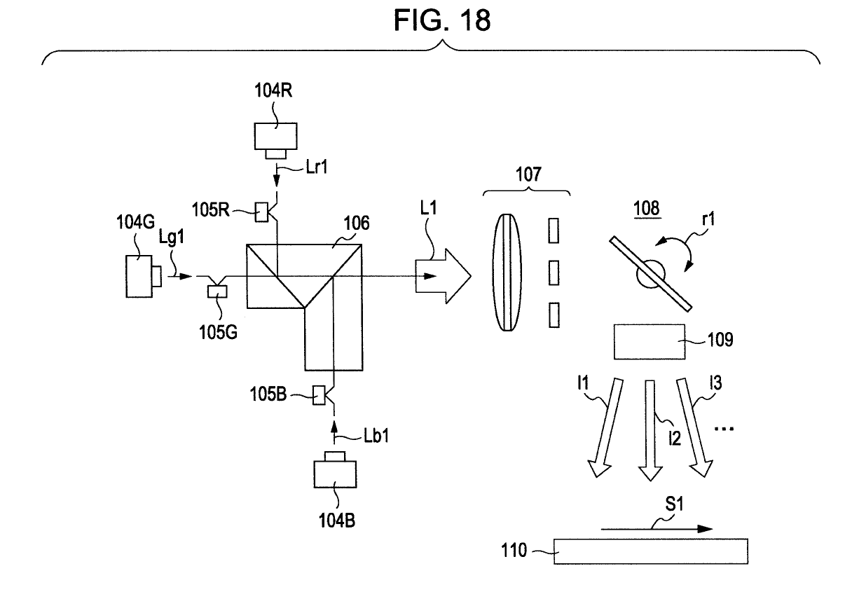

In an image forming apparatus of the related art, such a light modulation device module 200 is placed at different positions in the apparatus in an optically adjusted state, as described above with reference to FIG. 18. Optical adjustment is manually performed in a state in which an image is actually displayed on a display surface such as a screen. Thus, assembly and adjustment of the image forming apparatus includes a considerably troublesome operation.

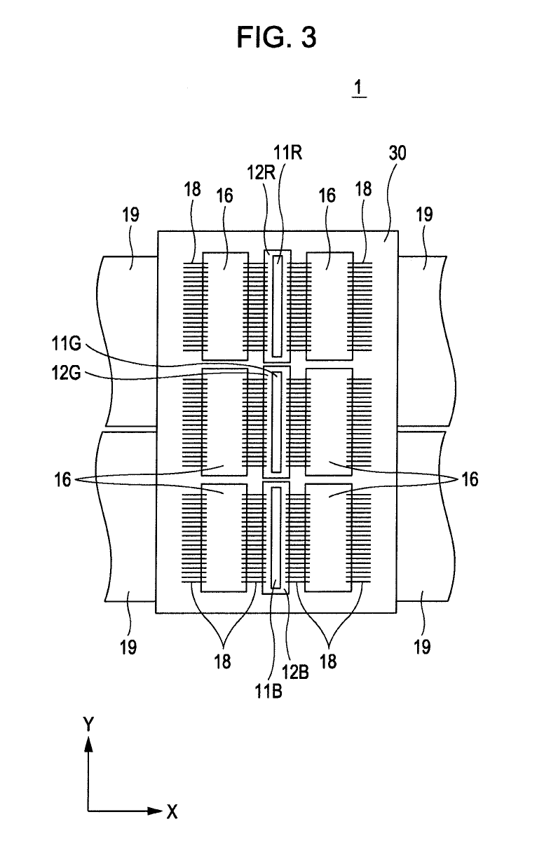

In contrast, in the light modulation device module 1 according to the embodiment of the present invention, as shown in FIG. 3, three light modulation devices 12R, 12G, and 12B having light modulation elements 11R, 11G, and 11B corresponding to a plurality of linear light beams in different wavelength bands are provided on the support member 30. In FIG. 3, portions corresponding to those shown in FIG. 1 are denoted by like reference numerals, and redundant descriptions thereof are omitted. In this embodiment, the light modulation elements 11R, 11G, and 11B in the light modulation devices 12R, 12G, and 12B are each of a one-order diffraction grating type such as a GLV. The light modulation devices 12R, 12G, and 12B are not arranged in the X-direction serving as the longitudinal direction of electrodes (not shown), but are arranged in the Y-direction orthogonal to the X-direction.

By thus arranging the light modulation devices 12R, 12G, and 12B corresponding to light beams in different wavelength bands on the single support member 30, the size of the image forming apparatus in which the light modulation device module 1 is incorporated can be reduced, and this reduces the cost. Further, once the positions of the light modulation devices 12R, 12G, and 12B are adjusted in the X-direction and Y-direction, misalignment among the devices does not occur, and the difference in linear expansion due to the temperature difference among the light modulation devices can be minimized. Therefore, pixel displacement can be reduced significantly.

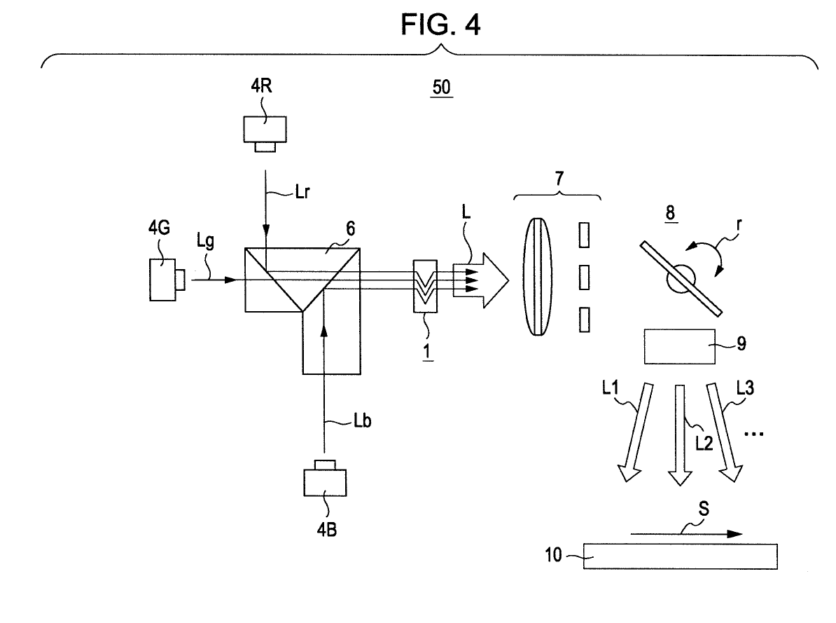

FIG. 4 is a schematic structural view of an image forming apparatus 50 according to the embodiment of the present invention using the light modulation device module 1 in which the light modulation devices 12R, 12G, and 12B, for example, corresponding to red, green, and blue colors are thus provided on the single support member 30. The image forming apparatus 50 includes light sources 4R, 4G, and 4B for respectively emitting laser light beams Lr, Lg, and Lb in red, green, and blue bands. The image forming apparatus 50 also includes a light combining unit 6, such as an L-shaped prism, which combines the laser light beams Lr, Lg, and Lb emitted from the light sources 4R, 4G, and 4B while adjusting the relative position among the optical axes of the light beams. The above-described light modulation device module 1 shown in FIGS. 1 and 3 is provided on the light emitting side of the light combining unit 6. Further, a space filter 7, such as a Schlieren filter, a scanning optical unit 8, such as a galvanometer mirror or a polygonal mirror, and a projection optical unit 9 including a group of projection lenses are arranged on the optical path of light L emitted from the light modulation device module 1.

In this image forming apparatus 50, the laser light beams Lr, Lg, and lb in the color bands emitted from the light sources 4R, 4G, and 4B are concentrated to a predetermined spot size in the X-direction by light collecting lenses such as cylindrical lenses (not shown), and are collimated to a predetermined width in the Y-direction, and then enter the light combining unit 6. The relative position among the light beams Lr, Lg, and Lb is adjusted in the light combining unit 6, and the light beams Lr, Lg, and Lb are converted into three light beams whose optical axes are shifted by a predetermined amount in a predetermined direction. The color light beams enter the light modulation device module 1, and the corresponding light modulation devices are independently driven according to input signals from a driving unit (not shown). For example, electrodes of light modulation elements of a diffraction grating type are controlled, and modulated light beams L are emitted outside.

The modulated light beams L emitted from the light modulation device module 1 are combined into one light beam by a mirror (not shown), or a color synthesizing unit, such as a prism, as appropriate, the combined light beam then enters the space filter 7 provided on the Fourier plane. For example, one-order diffracted light is selected by the space filter 7, and enters the scanning optical unit 8 via an imaging lens (not shown). The diffracted light is then reflected by the scanning optical unit 8, is projected onto a display surface 10, such as a screen, by the projection optical unit 9, as shown by arrows L1, L2, L3, . . . , and is scanned onto the display surface 10, as shown by arrow S, whereby an image is formed on the display surface 10.

As described above, when the light modulation device of a one-order diffraction grating type shown in FIGS. 15 to 17 is applied to the light modulation devices, light is blocked by the space filter 7 in a state in which the movable electrodes do not operate. In an operation state in which a driving voltage is applied to the movable electrodes, for example, ±1-order diffracted light is emitted, and passes through the space filter 7. By controlling the driving voltage applied to the movable electrodes, the on/off state of light projected onto the display surface 10 can be controlled, and the intensity of diffracted light can be changed for gradation control.

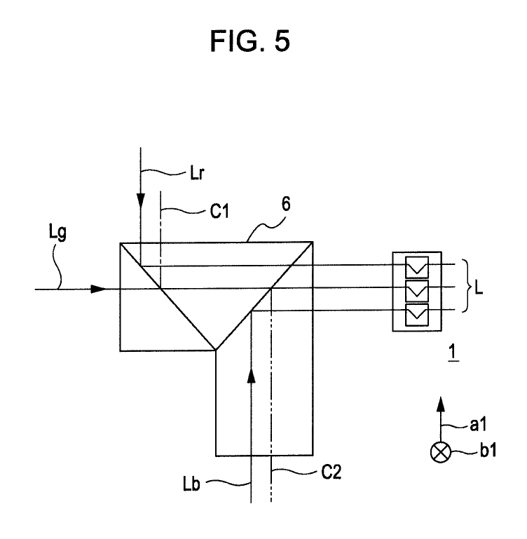

FIG. 5 shows an example layout of the light combining unit 6 in a case in which the light modulation devices 12R, 12G, and 12B having the above-described structure are arranged on the single support member 30 to constitute the light modulation device module 1, as shown in FIG. 3. FIG. 5 is an enlarged plan view of the light combining unit 6 in the image forming apparatus 50 shown in FIG. 4. In this case, the light combining unit 6 is formed by an L-shaped prism. Light beams emitted from the light sources enter the light combining unit 6 with their optical axes partly shifted. In the example shown in FIG. 5, the green light beam Lg is incident along the optical axis of the light combining unit 6, while red light beam Lr and the blue light beam Lb are incident while deviating from the optical axes shown by a one-dot chain line Cl and a two-dot chain line C2. By thus shifting the incident positions, the relative position among the emitted light beams is adjusted. In this case, mirrors (not shown) for guiding incident light to the light modulation devices (not shown) are shifted in a direction orthogonal to the light traveling direction.

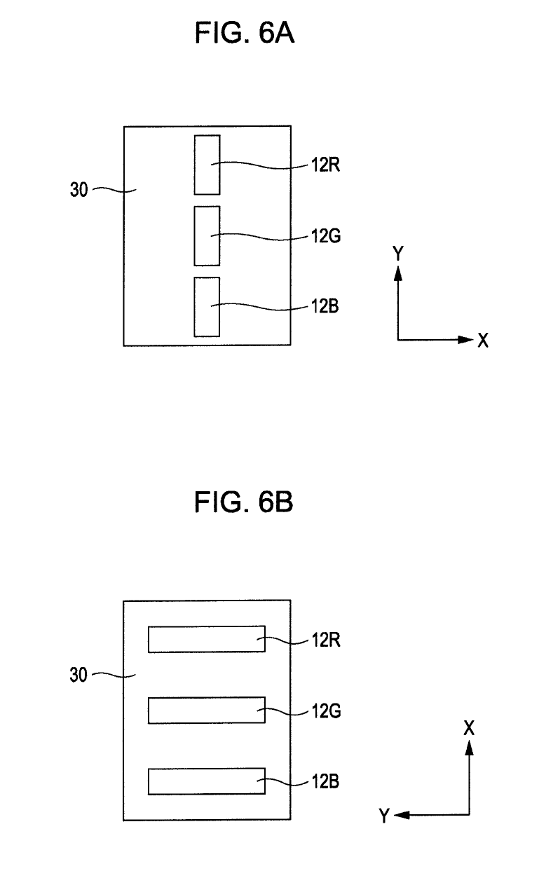

In FIG. 3, the light modulation devices 12R, 12G, and 12B corresponding to the colors are arranged in the Y-direction serving as the longitudinal direction of the linear light beams. FIG. 6A schematically shows the configuration in this example. In FIG. 6A, the longitudinal direction of linear light beams emitted from the light sources (not shown) is a direction al in FIG. 5, which is orthogonal to the optical axis of the light L emitted from the light modulation device module 1 and that extends along the paper plane of FIG. 5.

In contrast, the light modulation devices 12R, 12G, and 12B may be arranged in the X-direction orthogonal to the Y-direction, as shown in FIG. 6B. In this case, the longitudinal direction of the linear light beams is a direction b1 in FIG. 5, which is orthogonal to the optical axis of the emitted light L and orthogonal to the paper plane of FIG. 5.

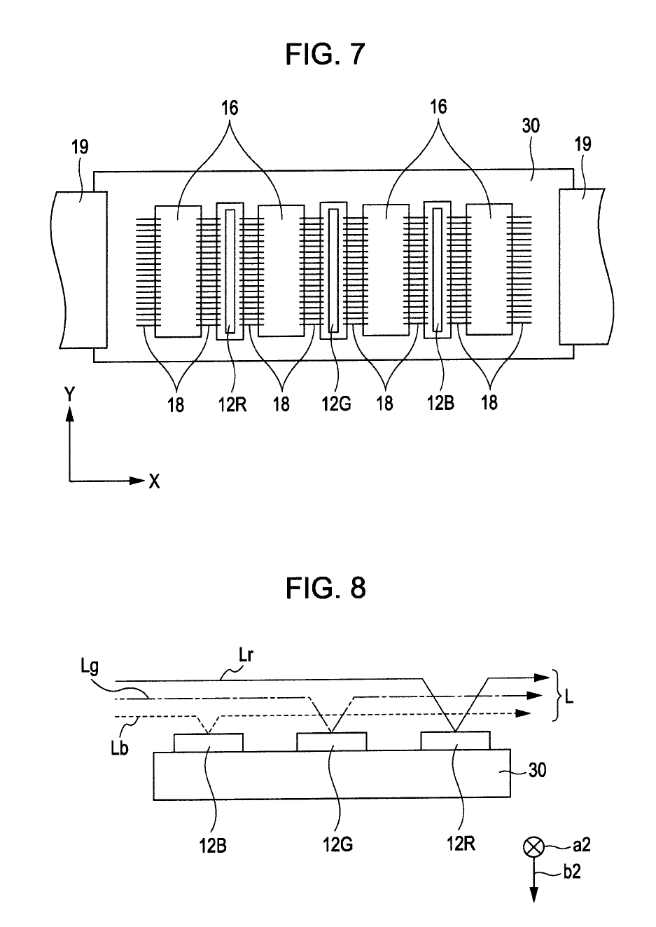

In the examples shown in FIGS. 6A and 6B, the light modulation devices 12R, 12G, and 12B are arranged in the directions orthogonal to the traveling direction of the light L. Conversely, the light modulation devices 12R, 12G, and 12B can be arranged in the light traveling direction, as shown in FIG. 7. In FIG. 7, the X-direction serves as the traveling direction of the light L, and the light modulation devices 12R, 12G, and 12B are arranged in the X-direction to constitute the light modulation device module 1. In FIG. 7, portions corresponding to those in FIG. 3 are denoted by like reference numerals, and redundant descriptions are omitted.

FIG. 8 schematically shows an incident state of color light beams Lr, Lg, and Lb from the light combining unit (not shown) in this case. The optical axes of a light beam Lr (solid line), a light beam Lg (one-dot chain line), and a light beam Lb (broken line) are slightly separated in a manner similar to that adopted in FIG. 5, and are caused by mirrors (not shown) to enter the light modulation devices 12R, 12G, and 12B on the support member 30. In FIG. 8, the light modulation devices 12R, 12G, and 12B are arranged in the traveling direction of the light beams Lr, Lg, and Lb. The mirrors for guiding the incident light to the light modulation devices 12R, 12G, and 12B are also arranged in the light traveling direction while being shifted from one another.

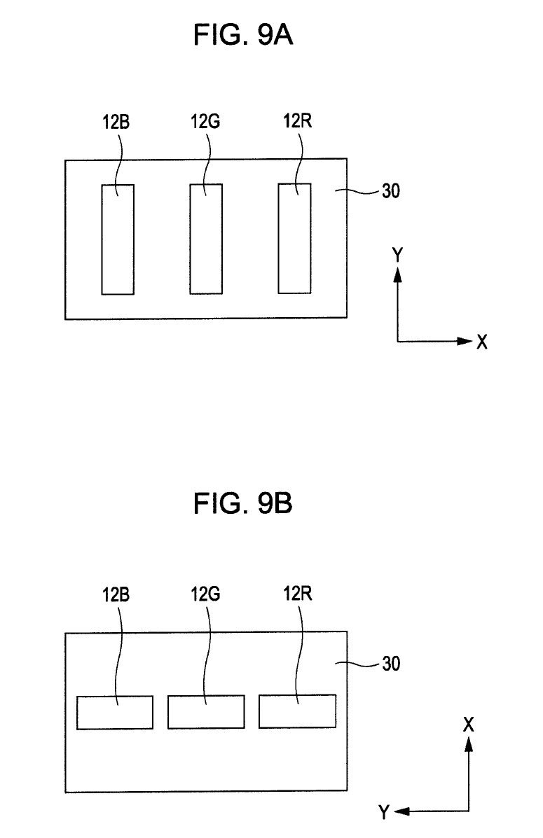

FIG. 9A schematically shows a configuration in which the light modulation devices 12R, 12G, and 12B are arranged in the X-direction, as in the light modulation device module 1 shown in FIG. 7. In this case, the longitudinal direction of linear light beams is a direction a2 in FIG. 8, which is orthogonal to the optical axis of the light L emitted from the light modulation device module 1 and orthogonal to the paper plane of FIG. 8.

As shown in FIG. 9B, the light modulation devices 12R, 12G, and 12B may be arranged in the Y-direction. In this case, the longitudinal direction of linear light beams is a direction b2 in FIG. 8, which is orthogonal to the optical axis of the emitted light L and extends along the paper plan of FIG. 8.

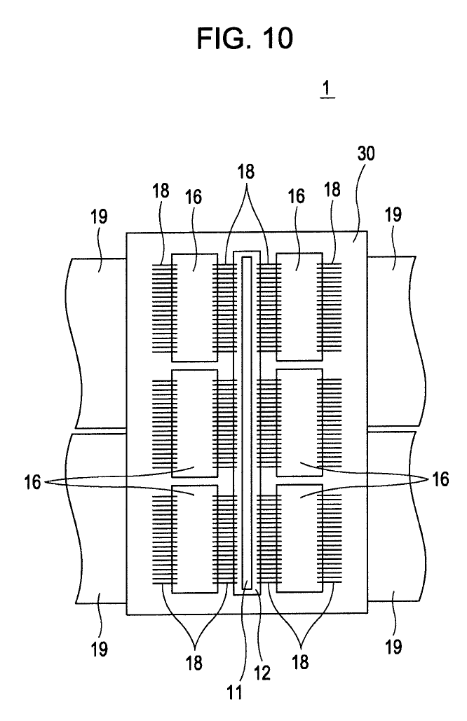

Alternatively, as shown in FIG. 10, the light modulation devices 12R, 12G, and 12B shown in FIG. 3 may be connected, that is, may be combined into a single light modulation device 12. In FIG. 10, portions corresponding to those in FIGS. 1 and 3 are denoted by like reference numerals, and redundant descriptions thereof are omitted. In this example, a single light modulation element 11 is provided in the light modulation device 12. Driving units 16 can be independently driven. For example, to apply light beams of three colors, red, green, and blue, the light modulation element 11 is divided into sections, and the color light beams are respectively applied to the sections for modulation, whereby color display is possible.

While six driving units 16 are provided for the light modulation element 11 in FIG. 10, the number of driving units 16 is not particularly limited. When the light modulation element 11 is integral, that is, light beams with a plurality of wavelengths are modulated by the single light modulation device 12, the positioning accuracy among the sections of the light modulation element 11 is not adjusted.

In this case, light beams with different wavelengths can be modulated in the sections of the single light modulation element 11. For example, in an application to a projector that projects a high-definition image with a light modulation element of a one-order diffraction grating type, 3240 pixels, which is three times 1080 pixels, are provided in the light modulation element. In this case, red light R, green light G, and blue light B may be divided into three from the top. Alternatively, the pixels may be driven in a mixed manner such that the first pixel is R, the second pixel is G, the third pixel is B, the fourth pixel is R, . . . , The relationship between the pixel and the light source from which light is applied to the pixel does not matter.

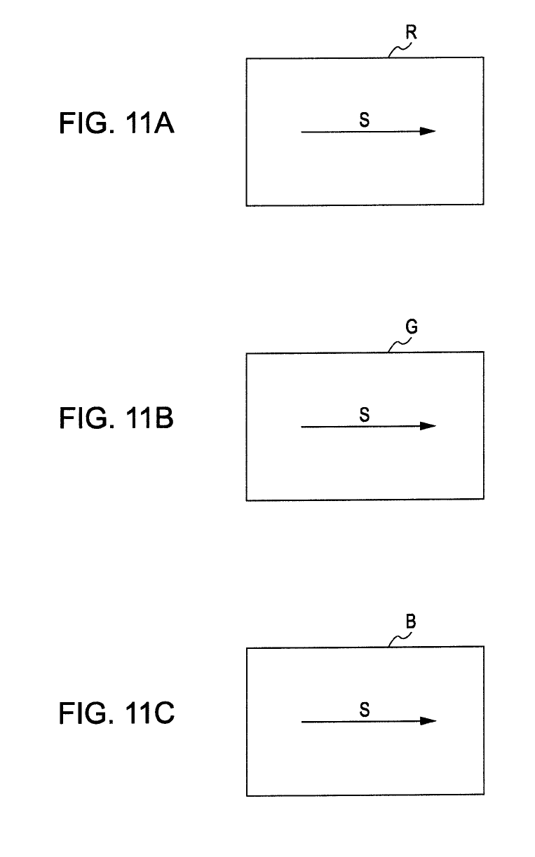

When this light modulation device module 1 is used, light beams with different wavelengths may be applied to spatially different pixels (electrodes corresponding thereto) by dividing the light modulation element 11 into sections, as described above, while they may be divided along the time axis. Time division allows light beams in different wavelength bands to be applied to the same pixel (a group of electrodes corresponding thereto). That is, as shown in FIGS. 11A to 11C, a red image R can be modulated for a predetermined time, a green image G can be modulated for the next predetermined time, a blue image B can be modulated for a predetermined time after the next predetermined time by the light modulation element 11, and the images can be scanned, as shown by arrow S, so as to display a color image.

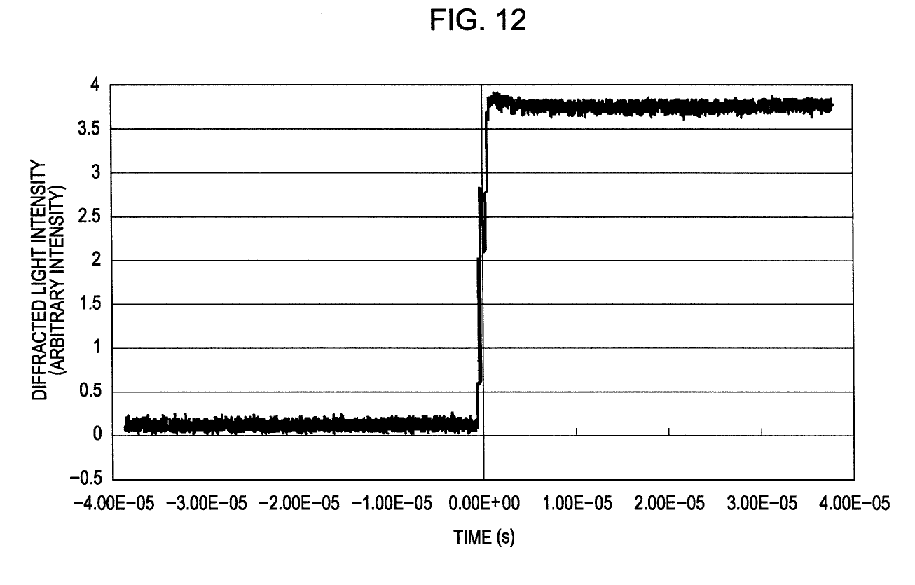

In such time division, for example, to display three colors, the driving time for one pixel becomes one-third. For example, when the above-described GLV is used as the light modulation element 11, the rise response speed thereof is 1.3 μs, which is quite high, as shown in FIG. 12. Therefore, even when a high-definition image is displayed in a 1/60 second, the response speed with respect to one pixel is 8.7 μs. When three colors are displayed by one modulation element, the response speed is 2.9 μs. These response speeds are satisfactory.

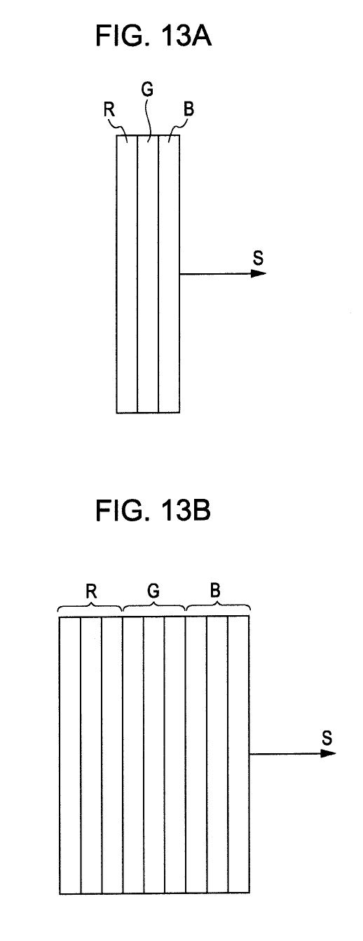

In time division, instead of performing display by the screen, as shown in FIGS. 11A to 11C, for example, one vertical image section in the scanning direction shown by arrow S in FIG. 13A can be displayed in the colors. Alternatively, as shown in FIG. 13B, several vertical image sections (three sections in the figure) can be regarded as a color image in one wavelength band, and R, G, and B colors can be displayed sequentially.

As described above, in the light modulation device module according to the embodiment of the present invention, the light modulation device corresponding to light beams in different wavelength bands is provided on the single support member. This makes optical adjustment easy, and reduces the size of the optical system.

Light beams with different wavelengths can be modulated in the same section in one light modulation element. For example, three colors can be displayed with one light modulation device by dividing the time axis into three and applying R, G, and B light beams onto the same pixel in order (in random order). For example, since the response speed of movable electrodes in a GLV light modulation element is sufficiently high, when images are high-definition images, 180 or more images can be projected in one second, and three colors can be achieved with the single light modulation element.

In the embodiment of the present invention, even when the support member 30 supporting the light modulation elements 12 (12R, 12G, and 12B) expands because of heat generation, the temperature difference among the light modulation elements corresponding to the colors can be minimized. For example, when a high-definition image is displayed, as described above, 1080 vertical pixels and 1920 horizontal pixels are used. Even when a displacement of a ¼ pixel is permitted, an accuracy corresponding to 1/4320 of the total vertical pixel size and 1/7680 of the total horizontal pixel size is provided. However, in the embodiment of the present invention, only a displacement of a ¼ pixel is corrected.

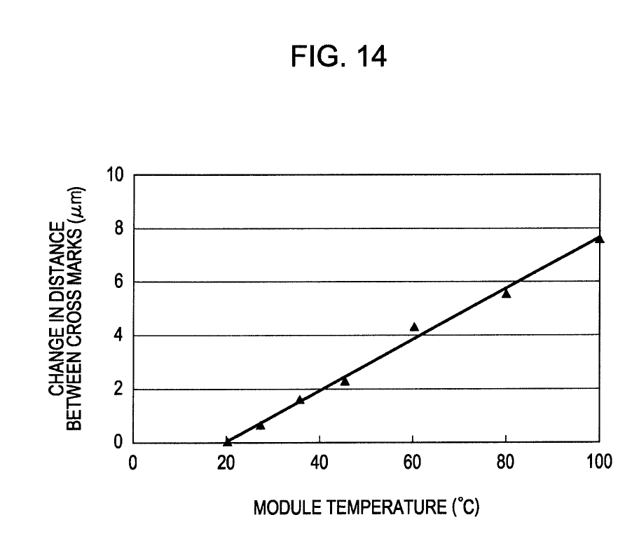

When the support member 30 is formed of A1₂O₃, the coefficient of thermal expansion thereof is about 1×10⁻⁶/K. A temperature difference of 1° C. causes a displacement of 3.1 ppm of the element length. FIG. 14 shows a state of thermal expansion at both ends of a light modulation element incorporated in an actual module. In this graph, cross marks are provided at both ends of the light modulation element, and a distance between the cross marks at 20° C. is used as the reference. The state in which the distance between the cross marks is increased by heat generation is plotted. The result shown in FIG. 14 reveals that, for example, a displacement of 0.93 μm occurs when there is a temperature difference of 10° C.

In contrast, in the light modulation device module 1 according to the embodiment of the present invention, since the light modulation devices 12 (12R, 12G, and 12B) are provided on the single support member 30, a temperature difference among the devices is not considered. Further, when the single light modulation device 12 is provided and light beams with different wavelengths are modulated in the same section, as shown in FIG. 10, the number of mirrors can be reduced. This can reduce the total size and cost of the image forming apparatus, and simplifies the configuration of the image forming apparatus.

The present application contains subject matter related to that disclosed in Japanese Priority Patent Application JP 2008-195483 filed in the Japan Patent Office on Jul. 29, 2008, the entire content of which is hereby incorporated by reference.

It should be noted that the present invention is not limited to the above-described configurations in the embodiments and that various modifications and alterations are possible without departing from the scope of the present invention.

What is claimed is:

1. A light modulation device module comprising:
a support member;
a light modulation device provided on the support member, the light modulation device modulating a plurality of linear light beams in different wavelength bands;
a driving unit configured to drive the light modulation device; and
a light transmitting member provided on the light modulation device.

2. The light modulation device module according to claim 1, wherein a plurality of the light modulation devices are provided corresponding to the plurality of light beams.

3. The light modulation device module according to claim 1, wherein the plurality of light beams in the different wavelength bands are modulated in a plurality of sections in the light modulation device.

4. The light modulation device module according to any one of claims 1 to 3, wherein the light modulation device includes light modulation elements of a diffraction grating type that are arranged one-dimensionally.

5. An image forming apparatus comprising:
a light source configured to emit light beams in different wavelength bands;
a light combining unit configured to combine the light beams from the light source;
a light modulation device module on which the light beams from the light source are incident after optical paths of the light beams are adjusted by the light combining unit;
a control unit configured to output a driving signal corresponding to an image signal to a light modulation device in the light modulation device module; and
a scanning optical unit configured to scan the light beams modulated by the light modulation device onto a display surface,
wherein the light modulation device module includes
a support member,
the light modulation device provided on the support member, the light modulation device modulating a plurality of linear light beams in different wavelength bands,
a driving unit configured to drive the light modulation device, and
a light transmitting member provided on the light modulation device.

6. A driving method for an image forming apparatus, the method comprising the steps of:
modulating linear light beams in different wavelength bands according to an image signal by a light modulation device of a one-dimensional diffraction grating type, the light modulation device being provided on a support member to form a light modulation device module; and
scanning the modulated light beams onto a display surface in a time division manner.

7. The driving method according to claim 6, wherein a plurality of the light modulation devices are provided in the light modulation device module, and the light beams in the different wavelength bands are respectively modulated by the plurality of the light modulation devices.

8. The driving method according to claim 6, wherein one light modulation device is provided in the light modulation device module, and the light beams in the different wavelength bands are modulated in sections of the light modulation device.
